(19) United States
(12) Patent Application Publication
(10) Pub. No.: US 2023/0130636 A1
(43) Pub. Date: Apr. 27, 2023

(54) INFORMATION PROCESSING DEVICE, INFORMATION PROCESSING METHOD, AND PROGRAM

(71) Applicant: Panasonic Holdings Corporation, Kadoma-shi, Osaka (JP)

(72) Inventors: Noriyuki SHIMIZU, Kanagawa (JP); Hideki KANEMOTO, Kanagawa (JP); Yuzo MORIUCHI, Mie (JP); Takeshi YASUNAGA, Kanagawa (JP); Rei HASEGAWA, Osaka (JP)

(21) Appl. No.: 17/906,282

(22) PCT Filed: Mar. 18, 2021
(86) PCT No.: PCT/JP2021/011167

§ 371 Date: Sep. 14, 2022

(30) Foreign Application Priority Data
Mar. 19, 2020 (JP) 2020-049539

(51) Int. Cl. H04W 16/28; H04W 52/36; H04W 16/22

(52) U.S. Cl. CPC H04W 16/28; H04W 52/367; H04W 16/22

(57) ABSTRACT

A communication apparatus mounted on a vehicle includes: a camera that captures a still image used for generating a map; a positioning circuit that positions a captured position of the still image; a control circuit that associates position information indicating the captured position with image data of the still image; and a communication circuit that establishes a radio communication with a roadside unit and transmits the image data by radio to the roadside unit, in which the control circuit rearranges an transmission order of the image data to be transmitted by radio to the roadside unit, based on the position information.

### TECHNICAL FIELD

The present disclosure relates to an information processing apparatus, an information processing method, and a program.

### BACKGROUND ART

When a radio system is built in a certain area by installing (placing) a base station in the certain area, the installation of the base station is determined so that the communication quality in the certain area satisfies a desired quality.

### CITATION LIST

### Patent Literature

### PTL 1

Japanese Patent Application Laid-Open No. 2019-140585

### SUMMARY OF INVENTION

For example, there is room for discussion in building a radio communication system considering directivity in radio communications performing directivity control of a millimeter wave band or the like.

A non-limiting example of the present disclosure facilitates providing an information processing apparatus, an information processing method, and a program that can build an appropriate radio communication system considering directivity in radio communications performing directivity control.

An information processing apparatus according to the embodiment of the present disclosure includes: an acquirer that acquires base-station information including transmission directivity information on a beam in at least one or more directions among beams in a plurality of directions, the beams being formable by a transmission antenna of a base station, and peripheral information on radio propagation in a space where the base station is installed; and a processor that estimates an intensity distribution of a radio wave, using a model indicating a correspondence relation between first base-station information and first peripheral information on one hand, and an intensity distribution of a radio wave radiated by the transmission antenna in the space on the other, the intensity distribution of the radio wave estimated by the processor being an intensity distribution of the radio wave radiated by the transmission antenna and corresponding to second base-station information and second peripheral information.

In an information processing method according to the embodiment of the present disclosure, the information processing apparatus acquires base-station information including transmission directivity information on a beam in at least one or more directions among beams in a plurality of directions, the beams being formable by a transmission antenna of a base station, and peripheral information on radio propagation in a space where the base station is installed; and estimates an intensity distribution of a radio wave, using a model indicating a correspondence relation between first base-station information and first peripheral information on one hand, and an intensity distribution of a radio wave radiated by the transmission antenna in the space on the other, the intensity distribution of the radio wave estimated by the processor being an intensity distribution of the radio wave radiated by the transmission antenna and corresponding to second base-station information and second peripheral information.

A program according to the embodiment of the present disclosure causes the information processing apparatus to execute processing including: acquiring base-station information including transmission directivity information on a beam in at least one or more directions among beams in a plurality of directions, the beams being formable by a transmission antenna of a base station, and peripheral information on radio propagation in a space where the base station is installed; and estimating an intensity distribution of a radio wave, using a model indicating a correspondence relation between first base-station information and first peripheral information on one hand, and an intensity distribution of a radio wave radiated by the transmission antenna in the space on the other, the intensity distribution of the radio wave estimated by the processor being an intensity distribution of the radio wave radiated by the transmission antenna and corresponding to second base-station information and second peripheral information.

It should be noted that general or specific embodiments may be implemented as a system, an apparatus, a method, an integrated circuit, a computer program, a storage medium, or any selective combination thereof.

According to an embodiment of the present disclosure, it is possible to build an appropriate radio communication system considering directivity.

Additional benefits and advantages of one embodiment of the present disclosure will become apparent from the specification and drawings. The benefits and/or advantages may be individually obtained by some embodiments and features described in the specification and drawings, which need not all be provided in order to obtain one or more of such features.

### BRIEF DESCRIPTION OF DRAWINGS

FIG. 1 is a diagram illustrating an exemplary information processing apparatus according to an embodiment;

FIG. 2 is a diagram illustrating exemplary information used for a learning process and/or an estimation process in the embodiment;

FIG. 3A is a diagram illustrating peripheral information #N illustrated in FIG. 2;

FIG. 3B is another diagram illustrating peripheral information #N illustrated in FIG. 2;

FIG. 4 is a table of exemplary information obtained in an estimation process;

FIG. 5 is a diagram illustrating a first example of a radio wave environment map;

FIG. 6 is a diagram illustrating a second example of the radio wave environment map;

FIG. 7 is a diagram illustrating exemplary peripheral information on a moving object;

FIG. 8 is a diagram illustrating exemplary information on a reception antenna; and

FIG. 9 is a diagram illustrating a relation between a transmission beam of a base station and a reception beam of a terminal.

### DESCRIPTION OF EMBODIMENTS

Hereinafter, a preferred embodiment of the present disclosure will be described in detail with reference to the appended drawings. Note that, in the present specification and drawings, components having substantially the same functions are provided with the same reference numerals, and redundant description will be omitted.

<Findings Leading to this Disclosure>

Frequencies for local 5G are open, and many companies and organizations are considering entry. Each company or organization applies for the license and designs an area for the introduction in accordance with the guidelines for the introduction of local 5G.

For building a local 5G system, the guideline standardizes the coverage area to be a minimum required range so as not to cause interference between a local 5G radio station provided in the area where the system is built and a local 5G radio station of a business telecommunications carrier having another license in the vicinity of the area.

When a coverage area and an adjustment target area of a local 5G radio station of a certain operator overlap with those of a surrounding local 5G radio station, the area is adjusted.

An appropriate station installation design of a base station is desired in the building of a local 5G system in which the coverage area is minimized. It is assumed that the station installation is designed based on the result of a radio propagation simulation.

The radio propagation simulation of the station installation design can be simulated by inputting base-station information involving radio propagation, such as an installation position of an antenna of the base station, a height of the antenna, an orientation of the antenna (e.g., tilt angle), and transmission power of the antenna; and peripheral information such as the layout and material of the structure around the base station.

In the radio propagation simulation of the station installation design, a method using machine learning has been investigated to efficiently perform calculation based on a large number of parameters (e.g., Patent Literature (hereinafter, referred to as PTL) 1).

By using machine learning, for example, the state of radio propagation can be estimated efficiently and in less calculation time without a comprehensive simulation even when peripheral information dynamically changes such as the opening and closing of the door and/or entering and leaving of persons. Thus, it is possible to confirm whether the operation is performed in accordance with the frequency sharing rules each time a change in peripheral environment occurs, such as a new building built around the base station and/or a change in the interior layout, and a temporary public construction; and it is possible to perform a simulation efficiently even when the design is reviewed.

Meanwhile, unlike a public network, local base stations installed in an office, a factory, or the like do not need to spread a coverage area in a planar manner. For example, there is a case where the service may be provided in some partial areas within the coverage area, such as a movement line of a working robot, a line of a factory, a conference room, and a periphery of a remote device. For example, in such a case, the local base station can reduce the power consumption of the base station by limiting the service area to the partial areas.

For example, controlling directivity has been considered for a local base station providing a service to a certain partial area in the coverage area by using a millimeter-wave band. The local base station can locally cover the partial area, for example, by forming a transmission beam in one or more particular directions.

However, for example, since the estimation of the state of radio propagation by machine learning described in PTL 1 does not consider directivity control of the base station, it cannot be said that the method for the station installation design covers a partial area with desired radio quality and reduces the power consumption.

Therefore, in a non-limiting embodiment of the present disclosure, the building of an appropriate radio communication system considering directivity in radio communications performing directivity control will be described.

### Embodiment

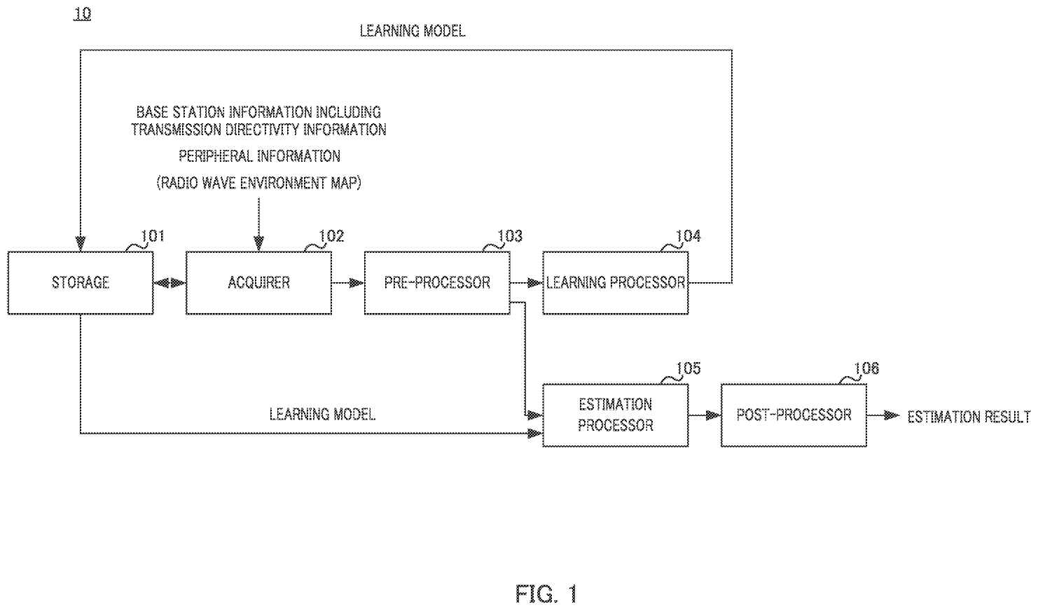

FIG. 1 is a diagram illustrating exemplary information processing apparatus 10 according to an embodiment. Information processing apparatus 10 illustrated in FIG. 1 includes, for example, storage 101, acquirer 102, pre-processor 103, learning processor 104, estimation processor 105, and post-processor 106. At least some of pre-processor 103, learning processor 104, estimation processor 105, and post-processor 106 may be collectively referred to as a processor. Note that, in information processing apparatus 10 illustrated in FIG. 1, two processes of a learning process and an estimation process are performed. Hereinafter, each process will be described with reference to FIG. 1.

<Learning Process>

Information processing apparatus 10 generates a learned model by performing machine learning using teacher information in the learning process, for example. Note that the term “learned model” may be referred to as “learning model”.

Storage 101 stores information for estimating a radio wave environment, a learned model of the radio wave environment, and the like. Storage 101 may store at least a portion of information acquired by acquirer 102.

Acquirer 102 is, for example, an interface for inputting information (data) to information processing apparatus 10. Acquirer 102 acquires, for example, base-station information and peripheral information, and information of a radio wave environment map corresponding to the base-station information and peripheral information. Incidentally, the information of the radio wave environment map represents, for example, an intensity distribution of a radio wave propagating in a certain space. The intensity distribution of the radio wave may be, for example, a distribution of the reception level (or radio quality). The information of the radio wave environment map may be generated, for example, by an external simulator, or may be obtained by simulation in information processing apparatus 10. Acquirer 102 outputs the acquired information to pre-processor 103.

Pre-processor 103 performs a pre-processing of the process of learning processor 104. For example, pre-processor 103 converts the information acquired from acquirer 102 and/or the information stored in storage 101 into information to be used in learning processor 104.

Illustratively, pre-processor 103 digitalizes the layout of the space that peripheral information indicates. For example, pre-processor 103 divides the layout of the space into mesh shapes, and determines the position of each mesh and values (e.g., reflectance, transmittance, attenuation, and the like) of the radio propagation of the material existing in the mesh. Further, pre-processor 103 performs coordinate transformation of peripheral information based on the position of the base station acquired by acquirer 102. For example, pre-processor 103 converts the coordinate of peripheral information from the absolute coordinate into the relative coordinate based on the position of the base station.

Learning processor 104 performs machine learning of radio propagation characteristics based on the information processed by pre-processor 103, and generates a learned model from the result of the machine learning. The method of machine learning in learning processor 104 is not limited, but a method using a neural network or the like may be applied, for example. Note that, in the learning process here, the correspondence relation between the base-station information and peripheral information and the information of the radio wave environment map corresponding to the base-station information and peripheral information acquired from acquirer 102 is leaned, and a learned model that models the correspondence relation is generated. Learning processor 104 stores the learned model obtained by the learning process in storage 101. Note that the information of the radio wave environment map corresponding to the base-station information and peripheral information, which is used by learning processor 104, may correspond to teacher data (teacher information) in the learning process.

Note that, in the learning process, a plurality of sets of the base-station information and peripheral information and the information on the radio wave environment map corresponding to the base-station information and peripheral information may be learned. Further, the learning process may be repeatedly executed by a user or the like of information processing apparatus 10.

<Estimation Process>

Information processing apparatus 10 determines an estimation result of a radio wave environment map using a learned model in the estimation process illustratively.

Storage 101 stores information for estimating the radio wave environment, a learned model of the radio wave environment map obtained by the learning process described above, and the like.

Acquirer 102 acquires, for example, base-station information and peripheral information. Acquirer 102 outputs the acquired information to pre-processor 103. Note that the base-station information and peripheral information acquired by acquirer 102 here may be information acquired in the learning process described above, or may be information different from information acquired in the learning process.

Pre-processor 103 performs a pre-processing of the process of the estimation processor 105. For example, pre-processor 103 converts the information acquired from acquirer 102 and/or the information stored in storage 101 into information to be used in estimation processor 105. The conversion of the information in pre-processor 103 is the same as in the learning process, and therefore the description thereof is omitted.

Estimation processor 105 performs estimation of radio propagation characteristics based on the learned model stored in storage 101 and the information processed by pre-processor 103, and outputs the estimation result. The output estimation result is, for example, an estimation value of the radio wave environment map.

Post-processor 106 performs a post-processing of the estimation result. For example, post-processor 106 evaluates an estimation value with the estimation value of the radio wave environment map, which is the output of estimation processor 105. Post-processor 106 may generate a radio wave interference map, using the frequency utilization efficiency of the service area and/or the radio wave environment map of the neighboring other frequency sharing carrier and the estimated value; and may output the information on the area (position information) that needs to be adjusted and/or the estimated base station power consumption. Alternatively, post-processor 106 outputs the station installation design index calculated from the estimation value of the radio wave environment map.

Note that the case where information processing apparatus 10 performs the learning process and the estimation process has been described above, but the information processing apparatus that performs the learning process and the information processing apparatus that performs the estimation process may be different apparatuses. In this case, the information processing apparatus that performs the learning process may output information on the model obtained by the learning process to the information processing apparatus that performs the estimation process.

<Example of Information in Learning Process and Estimation Process>

Next, an example of information used in the above-described learning process and estimation process will be described.

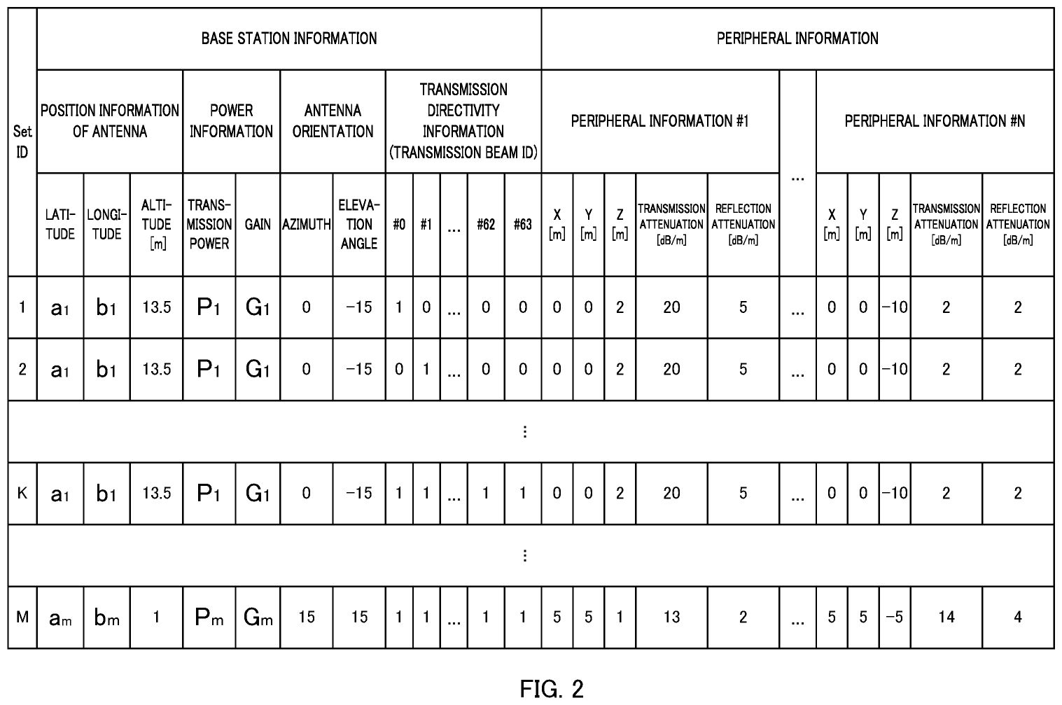

FIG. 2 is a diagram illustrating exemplary information used for a learning process and/or an estimation process in the embodiment.

Each row in FIG. 2 indicates a set of information input to learning processor 104 or estimation processor 105. An identification (ID) number for the set of information is given to each row.

The input information includes base-station information and peripheral information. The base-station information includes position information of an antenna, power information (transmission power and gain of the antenna), antenna orientation, and transmission directivity information (transmission beam ID).

The position information of the antenna is represented by, for example, latitude, longitude, and altitude. The altitude may be based on the floor surface of the space where the antenna is to be installed (that is, the altitude is 0 [m]), for example. Alternatively, when the space where the antenna is to be installed is on a certain floor of the building, the altitude may be based on the floor surface of the lowest floor of the building. Alternatively, the altitude may be represented by the elevation (or sea level).

The peripheral information represents, for example, information on an obstacle, such as a wall, existing at a position in a certain mesh in the space divided into mesh shapes. For example, the peripheral information includes X, Y, and Z coordinates representing relative coordinates from the position of the antenna, and includes the transmission attenuation and reflection attenuation of the obstacle existing in the coordinates. Note that X, Y, and Z coordinates of the peripheral information in FIG. 2 may be relative coordinates with respect to the position of the antenna, for example.

The base-station information includes a set (group) of transmission beam IDs. FIG. 2 illustrates an example in which the number of transmission beams that a transmission antenna can form is 64 and transmission beam IDs of #0 to #63 are given to the 64 transmission beams. Note that the transmission beam corresponding to ID #0 may be described as transmission beam #0 in the following. Here, the set of transmission beam IDs includes at least one transmission beam ID. The set of transmission beam IDs corresponds to an example of transmission directivity information.

For example, the information used in the learning process and/or the estimation process includes a set of transmission beam IDs to be used, and thus the learning process and the estimation of the radio wave environment map can be performed in each set of transmission IDs. This enables the station installation design that uses an appropriate transmission beam to cover a desired partial area while reducing the number of transmission beams.

For example, the type of information used in the learning process and the type of information used in the estimation process may be the same as or different from each other. For example, while every piece of information illustrated in FIG. 2 is input in the learning process, a part thereof may be omitted in the estimation process.

Note that the transmission directivity information may be information different from the set of transmission beam IDs. For example, the transmission directivity information may be an azimuth and elevation angle representing the direction of the transmission beam.

Further, the power information included in the base-station information may be set in accordance with the transmission directivity information. For example, the power information may be transmission power set for each of at least one transmission beam ID indicated by the transmission directivity information. For example, when the transmission beam ID indicated by the transmission directivity information is #0 and #1, the transmission power may be set for each of #0 and #1.

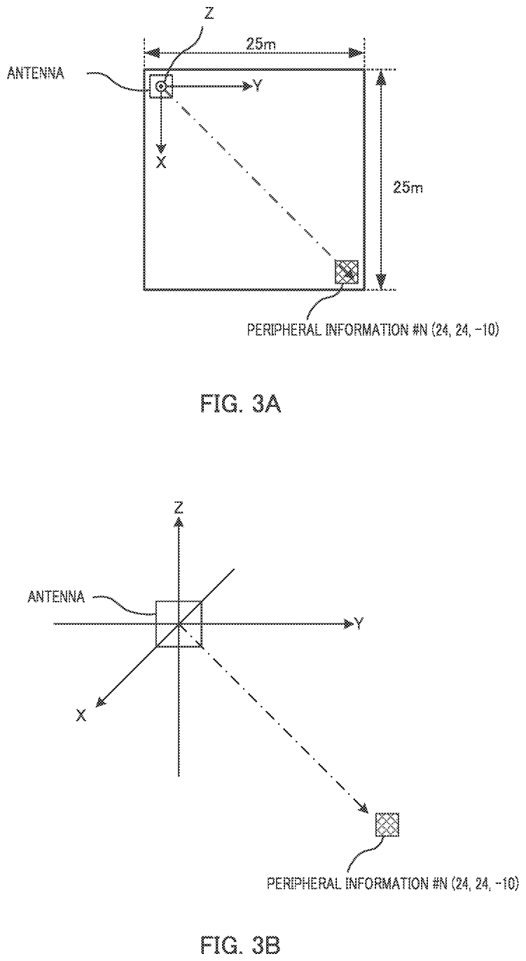

FIGS. 3A and 3B are diagrams illustrating peripheral information #N illustrated in FIG. 2. FIGS. 3A and 3B each illustrate a Z-axis that defines a height direction and an X-axis and Y-axis that define an X-Y plane perpendicular to the height direction. FIG. 3A is an overhead view from the positive direction of the Z-axis, and the area of 25 m square is a service area. Note that X, Y, and Z coordinates in FIG. 2 may correspond to the coordinates of the three-dimensional space illustrated in FIGS. 3A and 3B.

For example, peripheral information #N illustrated in FIG. 3A is positioned at the coordinates (X, Y, Z=24, 24, −10) based on the position of the antenna. Note that peripheral information #N may correspond to a fixed obstacle such as a wall or a door, for example. Since the coordinates of the peripheral information are relative values, the coordinates of peripheral information #N may change in accordance with a change in the position of the antenna.

<Example of Estimation Result in Estimation Process>

Next, an example of an estimation result output in the estimation processing will be described.

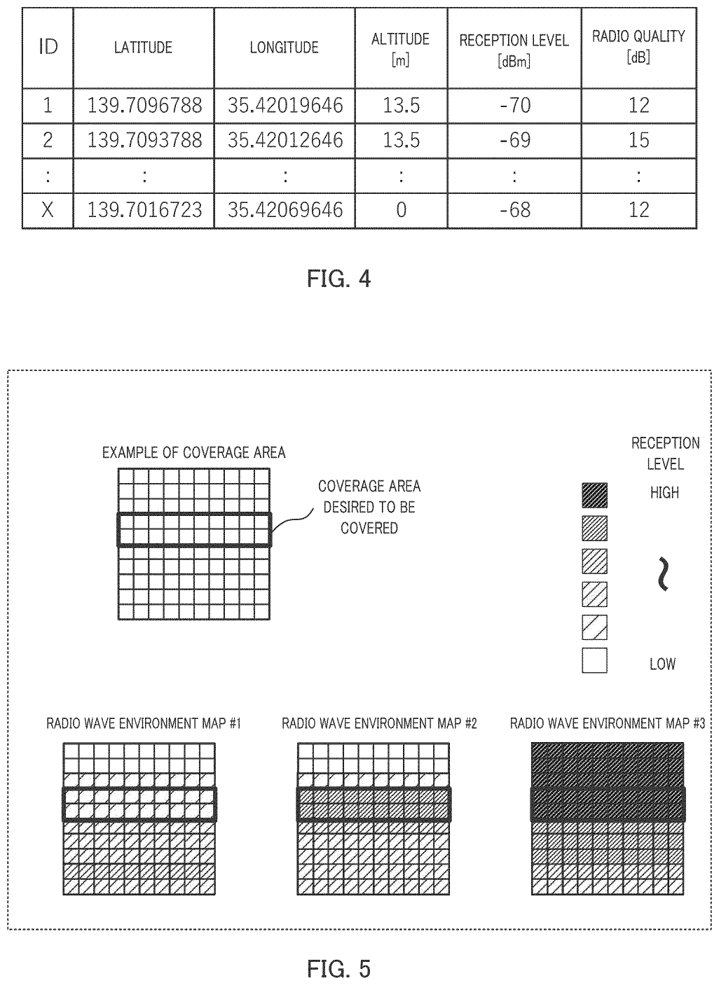

FIG. 4 is a table of exemplary information obtained in an estimation process. In FIG. 4, an ID; latitude, longitude, and altitude; and reception level and radio quality are associated with each other. One ID may correspond to, for example, one mesh of the space divided in mesh shapes. X (X is an integer greater than or equal to 1) IDs of 1 to X in FIG. 4 may correspond to X meshes. The latitude, longitude, and altitude associated with a certain ID represent coordinates of a representative point of the corresponding mesh. Further, the reception level and radio quality associated with a certain ID indicate, for example, the reception level and the radio quality at the representative point of the corresponding mesh.

In the estimation process, the estimation of the radio wave environment map based on the learned model is performed using the acquired base-station information and peripheral information, and the estimation result as illustrated in FIG. 4 is output. In the estimation process, an estimation result corresponding to the ID of one set of information illustrated in FIG. 2 is output, for example. An estimation result corresponding to the set of the input information is output.

Next, a radio wave environment map as an estimation result will be exemplified.

FIG. 5 is a diagram illustrating a first example of a radio wave environment map. FIG. 5 illustrates, for example, three radio wave environment maps in the case where a plane of 25 m×25 m at a certain altitude is divided into meshes of 2.5 m×2.5 m, and the reception level of each mesh is divided into six levels. Further, FIG. 5 illustrates a partial area (coverage area) desired to be covered in the same plane.

For example, radio wave environment map #1 has a low reception level in the coverage area compared to radio wave environment map #2 and radio wave environment map #3. Radio wave environment map #3 has a high reception level in the coverage area compared to radio wave environment map #2 and radio wave environment map #1. However, it is assumed that radio wave environment map #3 has a high reception level in the outside of the coverage area compared to radio wave environment map #2 and radio wave environment map #1 and thus has high power consumption.

For example, among the three radio wave environment maps illustrated in FIG. 5, the radio wave environment map that satisfies the condition in which power consumption can be reduced and a reception level of a predetermined level or higher can be secured in the coverage area is radio wave environment map #2. Such a determination may be performed, for example, by post-processor 106. For example, post-processor 106 outputs one or more estimation results satisfying a predetermined condition among a plurality of estimation results. Note that post-processor 106 may output input information (base-station information and peripheral information) associated with the estimation result.

For example, when there are one million sets of input information, there are also one million estimation results. Post-processor 106 may narrow down such many estimation results to determine an estimation result satisfying a certain condition as described above.

Further, as described in FIG. 2, when the transmission power is set for each of at least one or more transmission beam IDs indicated by transmission directivity information, tuning of the transmission power may be performed with respect to the result of the narrowing down.

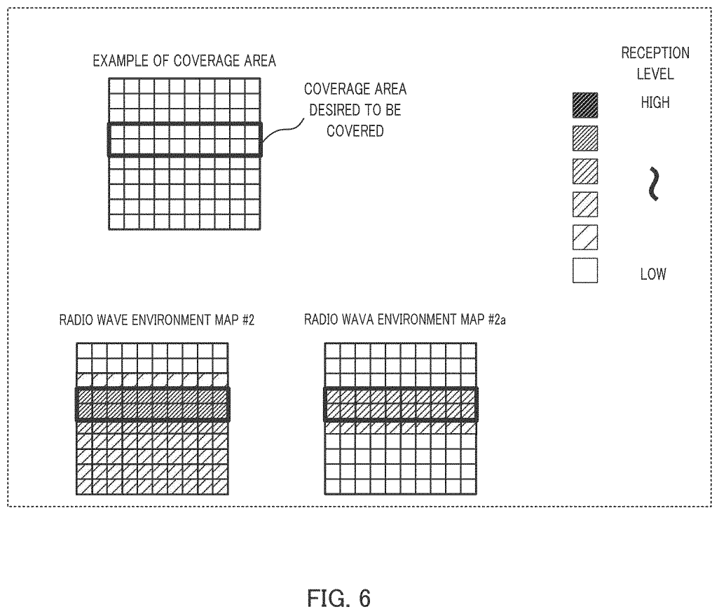

FIG. 6 is a diagram illustrating a second example of a radio wave environment map. Two radio wave environment maps of the same division of area and the same reception level as those in FIG. 5 are illustrated in FIG. 6. Note that radio wave environment map #2 in FIG. 6 is the same as radio wave environment map #2 in FIG. 5.

Radio wave environment map #2a in FIG. 6 is an example in which transmission power is set for each of transmission beam IDs in the input information (base-station information and peripheral information) associated with radio wave environment map #2. For example, radio wave environment map #2a is an estimation result in which at least a portion of the transmission power of the transmission beam IDs is set to a value lower than the transmission power of radio wave environment map #2.

For example, when the priority is given to reducing power consumption rather than enhancing the radio quality in the coverage area, it is determined that radio wave environment map #2a is a more suitable result according to the condition than radio wave environment map #2.

For example, when the power information is set for each of at least one transmission beam ID indicated by transmission directivity information, a more detailed estimation of the radio wave environment map can be performed, and thus more suitable output in the station installation design can be obtained.

In the present embodiment described above, acquirer 102 of information processing apparatus 10 acquires base-station information including transmission directivity information of a beam in at least a part of directions among beams in a plurality of directions that can be formed by the transmission antenna of the base station, and peripheral information on radio propagation of the space where the base station is installed. Using a learned model that indicates a correspondence relation between the base-station information (e.g., the first base-station information) and peripheral information (e.g., the first peripheral information) and the intensity distribution of the radio wave radiated by the transmission antenna in the space, the processor estimates an intensity distribution corresponding to the base station (the second base-station information) and peripheral information (the second peripheral information) acquired by the estimation process. As described above, information processing apparatus 10 can build an appropriate radio communication system considering directivity in radio communications performing directivity control by using information including transmission directivity information. For example, it is possible to perform the estimation process with the generated learned model, execute an estimation of a radio wave environment map, and realize an appropriate station installation design.

Note that the peripheral information is not limited to information on a still object in the space. For example, the peripheral information may include information on a movable portion in the space. Here, the movable portion may be, for example, a door, a window, a ventilation fan, an intake port, an exhaust port, or the like. In such a movable portion, the effect on radio propagation characteristics differs depending on the state (shape) of the movable portion. For example, in the case of a door, the reflection, transmission, and the like of a radio wave at the door when the door is open and when the door is closed are different.

For example, a parameter corresponding to the state in which the movable portion may be set in the peripheral information. For example, when there are a plurality of attenuations depending on the state in which the movable portion can be, the transmission attenuation (see FIG. 2) and the reflection attenuation of the movable portion may be minimized, and may correspond to the case of free space propagation on the assumption of the worst case in which the interference amount (giving interference amount) of the interference given to the adjacent base station is maximized.

Further, for example, the information on the state in which adverse effects on radio propagation characteristics are larger among the states in which the movable portion can be may be set in the peripheral information. For example, when the movable portion is a door, the degree of the radio wave (giving interference) leaking to the outside of the door is large when the door is open compared to the case where the door is closed. Therefore, in the peripheral information in the case where the movable portion is a door, information on the state in which the door is open may be set.

Further, the peripheral information may include information on a moving object that moves in the space. For example, the moving object may be a person, a working robot, a vehicle, a flying object, or the like. In this case, the peripheral information may include information on at least one of a position, a moving route, and a moving range of the moving object. Further, the peripheral information in this case may include staying time of the moving object. In addition, the peripheral information in this case may include a transmission parameter (e.g., transmission attenuation) and a reflection parameter (e.g., reflection attenuation) of the material of the moving object.

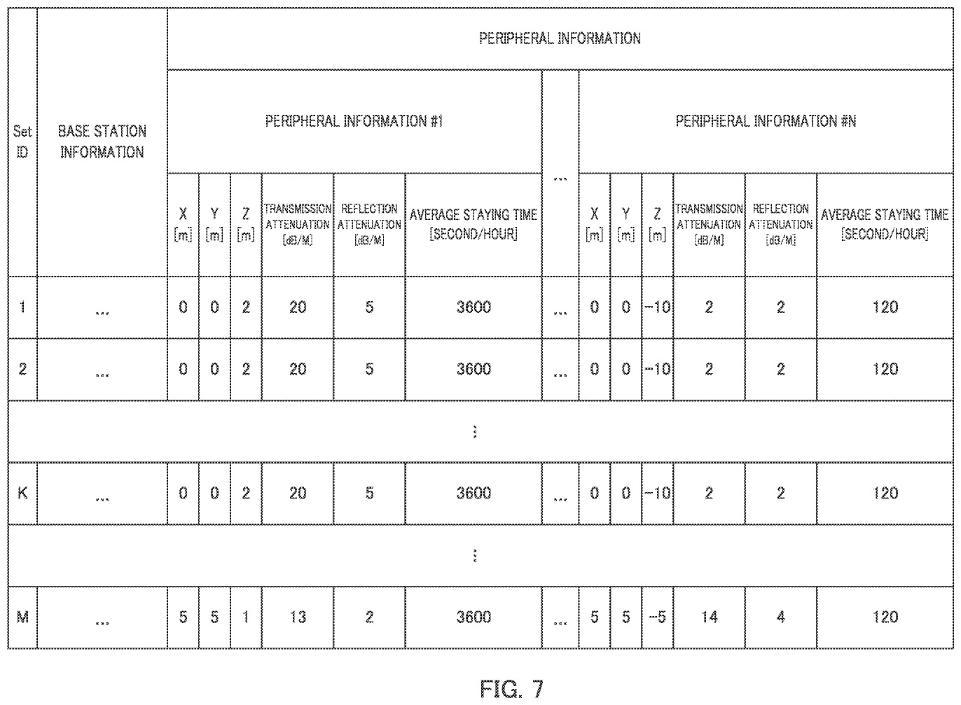

FIG. 7 is a diagram illustrating exemplary peripheral information on a moving object. FIG. 7 illustrates an example in which obstacles corresponding to peripheral information #1 and peripheral information #N illustrated in FIG. 2 are moving objects. Note that the same information as in FIG. 2 is omitted in FIG. 7.

For example, as illustrated in FIG. 7, more appropriate process can be executed in the above-described learning process and estimation process by the average staying time of each moving object included in the peripheral information, and an effective estimation can be efficiently obtained in the station installation design.

In the example described above, the example in which the input information is base-station information and peripheral information has been described, but the present disclosure is not limited thereto. For example, the input information may include information on a receiver (e.g., terminal) that is possibly positioned in the space (hereinafter, referred to as terminal information).

For example, at each position where a terminal in the space can be present, the terminal information may include information on a reception antenna (reception antenna information) which the terminal possesses. For example, the reception antenna information may include information on the installation direction of the reception antenna and information on the directivity of the reception antenna. The information on the directivity of the reception antenna may include a reception beam ID of the terminal, similar to the set of transmission beam IDs illustrated in FIG. 2, for example.

FIG. 8 is a diagram illustrating exemplary information of a reception antenna.

FIG. 8 illustrates an example in which the reception antenna orientation (azimuth and elevation angle) is set in the range of 0° to 359° and the reception antenna forms reception beams of ID #0 to ID #31. In the example illustrated in FIG. 8, different reception beam IDs are associated with the orientations of the same reception antenna. By such reception antenna information, more appropriate process can be executed in the above-described learning process and estimation process, and an effective estimation can be efficiently obtained in the station installation design.

The processing based on the reception antenna information is not limited. For example, a transmission beam may be selected based on the reception antenna information.

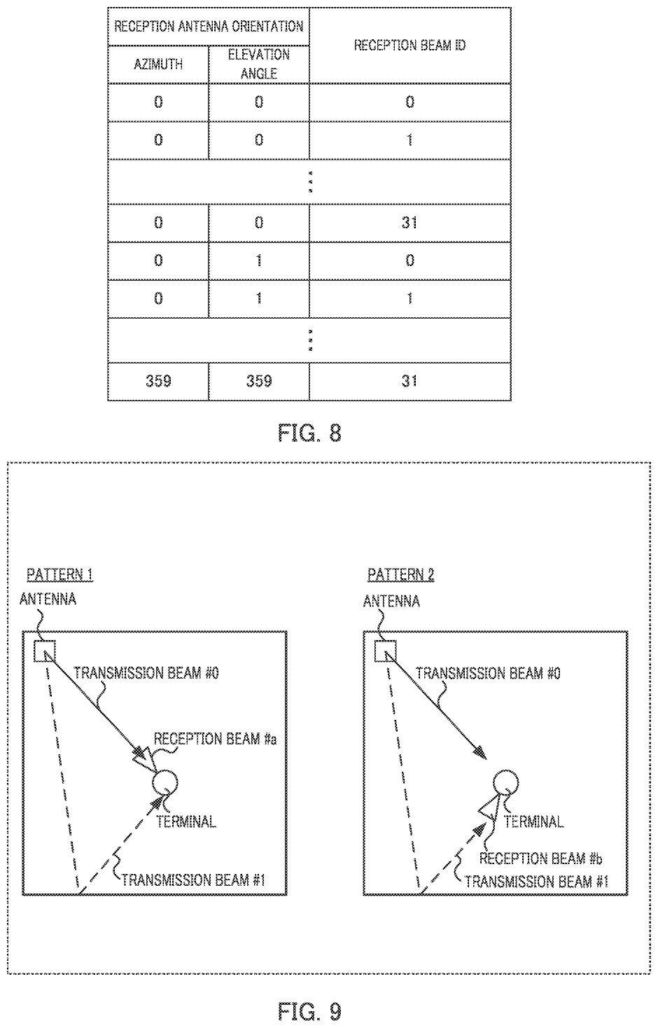

FIG. 9 is a diagram illustrating an exemplary relation between a transmission beam of a base station and a reception beam of a terminal.

Similarly to the example illustrated in FIG. 3A, FIG. 9 illustrates an antenna of a base station installed in the space, transmission beams formed by the antenna, a terminal positioned in the space, and a reception beam formed by the antenna. FIG. 9 illustrates two patterns in which the directions of the receiving beams are different. In each of two patterns, the antenna of the base station forms transmission beam #0 corresponding to ID #0 and transmission beam #1 corresponding to ID #1. In other words, two patterns in FIG. 9 correspond to an example in which a set of transmission beam IDs indicated by transmission directivity information includes #0 and #1.

Reception beam #a formed by the terminal in pattern 1 in FIG. 9 is directed to the direction of transmission beam #0. Thus, it is determined that transmission beam #1 may be omitted in pattern 1.

Meanwhile, reception beam #b formed by the terminal in pattern 2 in FIG. 9 is directed to the direction of transmission beam #1. Thus, it is determined that transmission beam #1 may not be omitted in pattern 2.

As illustrated in FIG. 9, the direction of the suitable transmission beam depends on the direction of the reception beam formed by the terminal. In this case, the reception level in the terminal changes in accordance with the direction of the reception beam and the direction of the transmission beam.

In the above-described learning process, the reception level that changes in accordance with the direction of the reception beam and the direction of the transmission beam may be learned by the terminal information input. Further, in the above-described estimation process, the terminal information may be input, and the estimation result including the reception level that changes in accordance with the direction of the reception beam and the direction of the transmission beam may be output.

Note that, in the above embodiment, information in a table format has been exemplified, but the present disclosure is not limited thereto. The format of the information may be different from the table format.

In the above embodiment, the term “beam” may be replaced with “sector”. For example, “beam ID” may be read as “sector ID”.

The information processing apparatus according to each of the above-described embodiments may be configured as a computer apparatus including a processor, a memory, a storage, a communication device, an input device, an output device, a bus, and the like.

In the above-described embodiments, the term “ . . . er (or)” used for the name of a component may be replaced with another term such as “assembly”, “device”, “unit”, or “module”.

In addition, the expression “frequency band” in the embodiment described above may be replaced by other expressions such as “frequency”, “frequency channel”, “bandwidth”, “band”, “carrier”, “sub-carrier”, or “(frequency) resource”.

The present disclosure can be realized by software, hardware, or software in cooperation with hardware.

Each functional block used in the description of each embodiment described above can be partly or entirely realized by an LSI, which is an integrated circuit, and each process described in the embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

The technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communicator include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

Various embodiments have been described with reference to the drawings hereinabove. Obviously, the present disclosure is not limited to these examples.

Obviously, a person skilled in the art would arrive variations and modification examples within a scope described in claims, and it is understood that these variations and modifications are within the technical scope of the present disclosure. Each constituent element of the above-mentioned embodiments may be combined optionally without departing from the spirit of the disclosure.

While specific examples of the present disclosure have been described in detail above, these are merely illustrative and do not limit the scope of the claims. The art described in the claims includes various modifications and variations of the specific examples illustrated above.

The disclosure of Japanese Patent Application No. 2020-049539, filed on Mar. 19, 2020, including the specification, drawings and abstract, is incorporated herein by reference in its entirety.

### INDUSTRIAL APPLICABILITY

The present disclosure is suitable for a radio communication system.

### REFERENCE SIGNS LIST

10 Information processing apparatus
101 Storage
102 Acquirer
103 Pre-processor
104 Learning processor
105 Estimation processor
106 Post-processor

1. An information processing apparatus comprising:
an acquirer that acquires base-station information including transmission directivity information on a beam in at least one or more directions among beams in a plurality of directions, the beams being formable by a transmission antenna of a base station, and peripheral information on radio propagation in a space where the base station is installed; and
a processor that estimates an intensity distribution of a radio wave, using a model indicating a correspondence relation between first base-station information and first peripheral information on one hand, and an intensity distribution of a radio wave radiated by the transmission antenna in the space on the other, the intensity distribution of the radio wave estimated by the processor being an intensity distribution of the radio wave radiated by the transmission antenna and corresponding to second base-station information and second peripheral information.

2. The information processing apparatus according to claim 1, wherein
the processor generates the model from a result of machine learning that is based on the first base-station information and the first peripheral information, and the intensity distribution corresponding to the first base-station information and the first peripheral information.

3. The information processing apparatus according to claim 1, wherein
the transmission directivity information indicates a set including an identification number of each of one or more of a plurality of the beams.

4. The information processing apparatus according to claim 1, wherein
the transmission directivity information is an angle indicating a direction of the beam.

5. The information processing apparatus according to claim 1, wherein
the base-station information includes information on transmission power of each beam in the at least one or more directions.

6. The information processing apparatus according to claim 1, wherein
the peripheral information is selected from information corresponding to two or more states applicable to an obstacle of radio propagation in the space.

7. The information processing apparatus according to claim 6, wherein
the peripheral information selects, among the two or more states, a minimum attenuation in a state corresponding to radio transmission and a maximum attenuation in a state corresponding to radio reflection.

8. The information processing apparatus according to claim 1, wherein
the peripheral information includes information on a position and/or moving range of an object that moves in the space.

9. The information processing apparatus according to claim 1, wherein
the acquirer acquires terminal information on a reception beam in at least one or more directions among reception beams in a plurality of directions formable by a reception antenna of a terminal that possibly exists in the space.

10. The information processing apparatus according to claim 9, wherein
the terminal information is an angle indicating a direction of the beam.

11. An information processing method comprising:
acquiring, by an information processing apparatus, base-station information including transmission directivity information on a beam in at least one or more directions among beams in a plurality of directions, the beams being formable by a transmission antenna of a base station, and peripheral information on radio propagation in a space where the base station is installed; and
estimating, by the information processing apparatus, an intensity distribution of a radio wave, using a model indicating a correspondence relation between first base-station information and first peripheral information on one hand, and an intensity distribution of a radio wave radiated by the transmission antenna in the space on the other, the intensity distribution of the radio wave estimated by the processor being an intensity distribution of the radio wave radiated by the transmission antenna and corresponding to second base-station information and second peripheral information.

12. A program that causes an information processing apparatus to execute processing comprising:
acquiring base-station information including transmission directivity information on a beam in at least one or more directions among beams in a plurality of directions, the beams being formable by a transmission antenna of a base station, and peripheral information on radio propagation in a space where the base station is installed; and
estimating an intensity distribution of a radio wave, using a model indicating a correspondence relation between first base-station information and first peripheral information on one hand, and an intensity distribution of a radio wave radiated by the transmission antenna in the space on the other, the intensity distribution of the radio wave estimated by the processor being an intensity distribution of the radio wave radiated by the transmission antenna and corresponding to second base-station information and second peripheral information.
